(19) United States
(12) Patent Application Publication
(10) Pub. No.: US 2011/0186392 A1
(43) Pub. Date: Aug. 4, 2011

(54) HYDRAULIC DEVICE THAT COMMANDS AND ACTIONS SO AUTOMATIC THE BRAKE OF A PUMPING WINDMILL

(76) Inventors: Carlos Alberto Cardoso Del Alamo, Jaen (ES); Jorge Raul Morici, Santa Fe (AR)

(21) Appl. No.: 12/737,766

(22) PCT Filed: Aug. 10, 2009
(86) PCT No.: PCT/ES2009/000425

§ 371 Date: Feb. 14, 2011

(30) Foreign Application Priority Data
Aug. 15, 2008 (AR) A/2008/P.08010358

(51) Int. Cl. F16D 65/32

(52) U.S. Cl. 188/151 R

(57) ABSTRACT

Comprises a vertical cylinder whose rod of smaller diameter than the piston, is projected upwards out of the device to be linked to the brake mechanism of the mill, said hydraulic cylinder being enclosed within a cylindrical container larger diameter coaxial to define an annular chamber between them which acts as a deposit of oil that drives the piston displacement. To boost the oil stored in said annular chamber and transmitting hydraulic pressure to the piston, are used to using two suction pumps impellers single acting, located at the top of the set, which are activated by a rocker operated from the same pumping rod mill, while medium valve inserted in the oil circuit driven by said pumps single acting, causes the hydraulic cylinder piston moves the brake, when interrupted your back to the annular chamber. The medium valve inserted in the oil circuit driven pumps, is a directional valve contributor housed in a section of communication between the recirculation and return ducts into the annular chamber. Said directional valve contributor is associated with a float housed inside a cylindrical container provided on the water storage tank in communication with the interior.

### SUMMARY

The present invention patent main purpose is a HYDRAULIC DEVICE THAT COMMANDS AND ACTIONS, SO AUTOMATICS, THE BRAKE OF A PUMPING WIND MILL, such as usually called windmills to pump water, where this device command and drive, it is extremely effective to activate and deactivate the action of the pumping braking, depending on the volume of extracted water in their storage tank.

More concretely, the present invention patent protects a device hydraulic in order to command the brake possessing those mills that are constituted from a wheel or wheel carrier of a plurality of vanes, moved by the strength of the wind, which is available on a horizontal tree oriented by itself facing the wind by the action of a rudder, bringing about the revolving motion of an axis associated with the steering wheel, extending into a box of transmission where movement is transformed into a vertical displacement in fro, that it is transmitted to by a string of pumping rods through which a piston bomber extracts water from the well and moves it to an elevated storage tank .

The device invented to designed to activate and deactivate automatically the pre-existing brake resource that possesses the mill itself; which activate the braking action when water pumped, hosted inside the tank level reaches a predetermined maximum volume.

The same device is capable to release the brake, allowing the water pumping action resumes when the volume contained within the same tank is less than a predetermined minimum

To implement the purpose explained in the preceding paragraphs, the hydraulic device of command and drives combines the use of a particular hydraulic actuator able to pull a brake cable from the hydraulic pressure is generated from a tank hydraulic fluid acting in correspondence of which a few simple suction pumps impellers effect related to the pumping system own mill, and a directional valve activated by a float connected to the volume of water that sits in that storage tank.

Pressure hydraulic oil required for operation of said hydraulic actuator, comes from said two suction pumps and propelling, single direction, which act synchronized, associated with the same rocker that is directly driven by the pump rod mill, having a point equidistant rotation available to a link with two single pumps, so that together form a double acting pump.

Indeed, the novelty and advantages which highlights the hydraulic device command and drive of the present patent is the use of these two hydraulic pumps that act leveraging both directions of displacement swing of the pump rod so that it uses a wealth of oil that can cause the brake of the mill in a few strokes.

This is an invention that defines a new media mix designed to achieve superior results, being the same unpredictable and surprising even for an expert in the field. Consequently, apart from being new, constructive and functional conception shows a clear inventive, so that it meets the conditions required by the Law to be considered invention patent.

Prior Art

It is known that this type of mills required very efficient device for command and automatic control of the brake system because, in most cases, usually they are in remotes areas in the field, so the control maintenance is not so strict and regular as you want.

Consequently, if the automatic resource command and operated is not efficient may occur water spills by unwanted rebalse high storage or lack of water tank feeding ponds, drinking fountains, etc., because it remained unduly closed when the same storage tank is empty.

The same author of the present invention has developed previously an automatic device for to drive the brake of a mill, which also defines a hydraulic actuator which in this case includes a crankase, whose interior it is coaxially located a closed shirt inside which extends a piston that projects outside through the lower base shirt and the crankase

In this case, free mentioned piston which is projected outside it takes means connection with the system of the brake of the mill so that when it move in a sense it command and operate brake, while when it move in the opposite direction, releases the brake.

To produce such displacement piston is used hydraulic energy since it is possible to confer the necessary strength so that the piston effectively operate the brake of the mill.

To do it in the annular space determines between shirt and the crankase, is located the spout suction with the corresponding check valve pump piston, whose output, using a conduit that carries a check valve, proxy communicates with the interior of the shirt, and this in turn, on a check valve piloted by a needle with the interior of the crankcase.

Relies on the use of a single pump piston which acts with the own mill pumping movement.

At the same time the mentioned needle is connected to a float housed in the mill water tank so that when the volume of water is at a maximum level, this needle produces the closing to valve in communication with crankcase, causing the referred piston drives the brake of the mill.

When the volume of water in the tank of the mill comes to a minimum, the needle valve opening occurs in the communication with the crankcase, recovering the integral circulation of the hydraulic fluid so that the displacement of the ‘piston does not activated freeing itself the brake

Althoug this realization has given satisfactory results, it must be said that uses only 50% of the pumping motion of the mill itself to generate the hydraulic fluid moves through which activate on or off the automatic brake.

It is a realization that requires many piston strokes to transmit a hydraulic pressure sufficient to achieve the movement of the piston with the force required to activate the brake of the mill.

Advantages of Invention - Main Object

In this case, for to drive the brake a mill, the device the action and command of this patent also includes the use of a hydraulic actuator, in this case includes a vertical hydraulic cylinder whose rod of smaller diameter its piston is projected upwards out of the device, which is linked to the drive mechanism of the mill mechanical brake. The said hydraulic cylinder is enclosed within a coaxial cylindrical container with a larger diameter, defining an annular space between them that acts as a reservoir of hydraulic fluid used for the movement of the piston.

In this particular case the invented device stands out because for displacement of stored fluid said that confers hydraulic pressure at the piston , resorts to using two simple effect aspiring pumps, located at the top of the set and activated by a same rocker so that, when one rises another low

In this case is the rocker which transmits the alternate pump which produces mill, in such a way that, when the piston moves upward movement, hydraulic fluid evicted by the cylinder it returns to deposit to annul, at the same time that wears the fluid-driven both pumps to not block them.

In the opposite alternative position, the hydraulic fluid that drives the pumps is directed toward the top of the cylinder producing hydraulic pressure to move down to the piston and its rod so that they drive the brake and stop the operation of the mill.

A valvular means interspersed hydraulic fluid these pumps simple effect-driven circuit is that produces the same travelling applying the brake when interrupted his return to the annular deposit

Half cited valvular, is nothing more than a directional valve contributor which remains linked to a hosted inside a cylindrical container that is available adjacent to the referred main cylindrical container float.

The bottom of this container, connected to the line of movement of the mill way you level up bringing to the floating when the volume of this water at a maximum level and the operation of the mill should be stopped while floating it descends to the lower level there will be an automatic brake release.

Aforementioned condition of resorting to the use of two pumps simple effect acting alternately with the piston strokes mill, is conferred this device command and hydraulic drive, clear advantages of a functional nature compared to prior art.

It highlights again the fact that it provides a significant increase in hydraulic pressure applied to the piston, while it was possible to run a very simple assembly that facilitates the integral maintenance of the mill.

It also highlights the fact that the directional valve used optimizes the operation of hydraulic resource of the command it to be highly accurate and efficient than previously reported.

Inventive Activity

No command and drive device windmill brake which is known today suggests, even the constructive resolution suggests that arises as indicated in the preceding paragraphs, because of which is a proposal that in addition has a clear new inventive.

### DESCRIPTION OF THE DRAWINGS

To realize the advantages and briefly discussed, to which users and those skilled in the specialty can add many more, and to facilitate understanding of the structural characteristics, functional constituencies and invented hydraulic device, described An preferred example of embodiment which illustrates schematically and without a certain scale in the attached sheets, with the express clarification that, precisely because it is an example, it does not correspond assing the same non-restrictive or exclusive range protection of this patent, but merely assists an intention merely explanatory and illustrative of the basic concept that underpins it.

FIG. 1 is a schematic external view that shows items involved to constitute the set command and automatic actuation is linked with the mill brake mechanism.

FIG. 2 is a longitudinal cut a vertical plane which allows you to verify such means that constitute the automatic device command and operation of the present invention hydraulic actuator mounting.

FIG. 3 is a functional layout that shows the arrangement of the media and the invented device elements when the mill brake is released.

FIG. 4 is a concept that shows the arrangement of the media and the invented device elements when the same mill brake is activated.

Clarifies that, in all figures to equal numbers and letters of reference, correspond the same or equivalent parts or elements of the set, as in the example chosen for this explanation invented hydraulic device.

### DETAILED DESCRIPTION OF THE PREFERRED EMBODIMENT

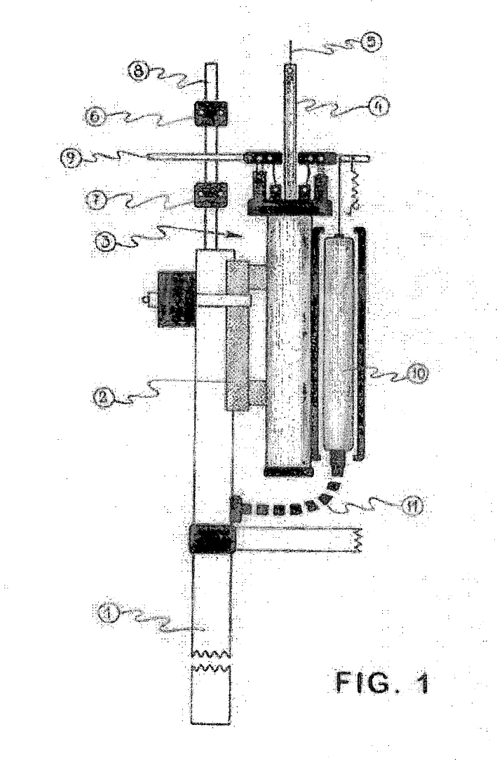

As you can see in FIG. 1, the hydraulic device command and operation referred to in the present patent of invention, it acts as a means for automatic closure servo assisted in wind mills water pumping

This figure demonstrates that from the pipe pump (1), through a loop for fastening (2), handle is mounted hydraulic actuator (3), appreciating the presence of the rod (4) that is projected by the upper base linking, through cable (5) with the brake mechanism.

This same FIG. 1, can also be seen pushers tops (6) and (7) mounted Rod pump (8) on the paper longiforme (9) to simultaneously transmit a reciprocating suction and impellers pumps

This figure shows a case where, adjacent to the body of the actuator (3) is located cylindrical container (10) which houses, inside the floating commands the movements of the directional valve, for which it is connected, through flexible conduit (11) with said pumping pipe (1).

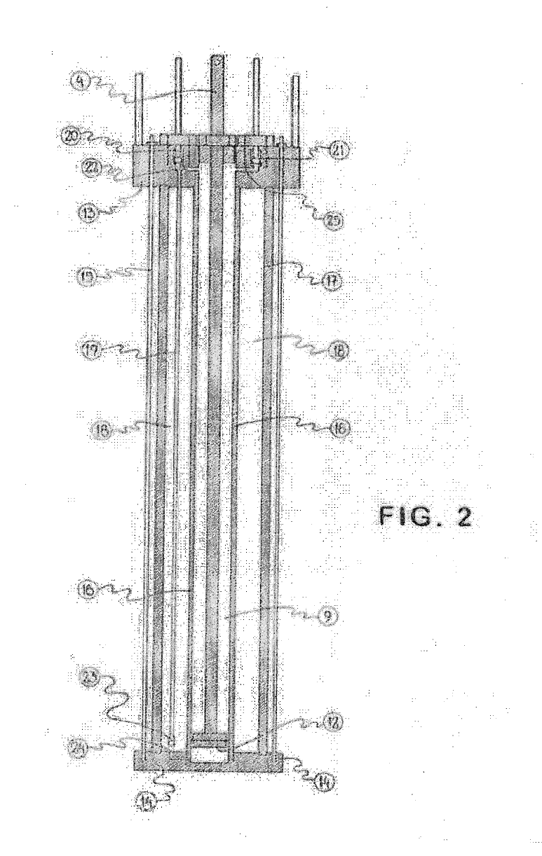

Observing now FIG. 2, it is possible to appreciate what constitutes a preferred embodiment of said hydraulic actuator (3) that device invented use to actuate the brake mechanism from the stem (4) of the piston (12).

This actuator is constituted with an upper lid (13) and a lower cap (14) that is maintained properly positioned across adjustment rod (15), defining an internal hydraulic cylinder (16), inside which the piston housing (12) whose stem (4) is projected through the top cover (13) to extend to partner with the brake mechanism mill (not shown).

As noted above, the hydraulic cylinder (16), is housed, coaxially inside the cylindrical container (17) defining an internal annular chamber (18) which contains the hydraulic fluid drive, maintaining between them, a corresponding lower communication (24).

In this FIG. 2 also shows the suction pipe (19) whose free lower end of which carries a check valve (23), which extends to the suction and impeller pump(20) mounted on said top cover (13), associated to the duct (22) which provides superior communication with the interior of the hydraulic cylinder (16).

In this same figure shows also the second suction impeller pump (21) and conduit for internal communications (25), clearing the plane court prevents from seeing the spout suction that hosted on the same internal annular chamber (18) to lead the fluid seeking pump (21).

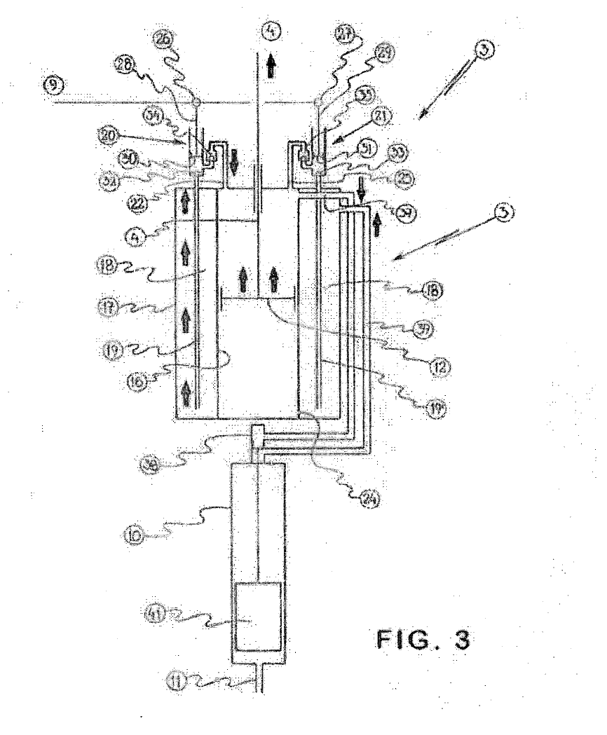

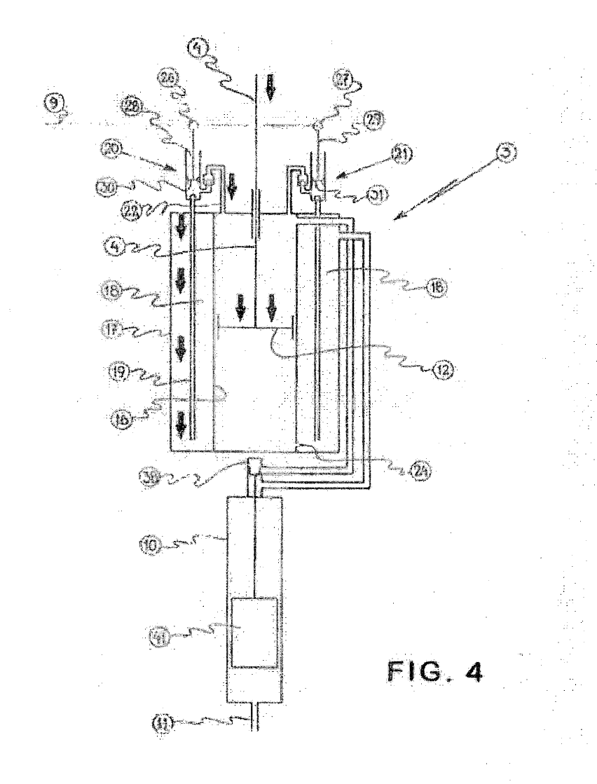

Thus constituted Assembly, FIGS. 3 and 4 has been added to show the principle of operation of the invented device.

Shown that through upward and downward movements of the pumping rod, the elongated fork (9), through corresponding joints (26) and (27), acts on offshoots (28) and (29) pumps (20) and (21), producing alternative movement of ascent and descent to their respective piston (30) and (31).

During the ascent, each of these pistons generates a vacuum that opens their respective valve (32) and (33), aspiring through its corresponding tubes for suction (19) and (19′) oil from annular chamber (18).

In upstrokes, each of the above-mentioned pistons (30) and (31), also opening up their respective valve (34) and (35) sending oil to the high chamber (36) the hydraulic cylinder (16) whose piston (12) is kept high by the work of the return spring mechanism of the mill brake (not illustrated), (4) connected to the stem

In both FIGS. 3 and 4, can be seen also which, when the piston is and remains high, both pumping oil pumps (20) and (21) turn, it is displaced through recirculation (37) to the point where sits directional valve (38) contributor sandwiched with the communication towards the duct (39) return the same fluid into the aforementioned internal annular chamber (18).

Highlights the above-mentioned valve (39) has a through hole (40) through which it maintains matched internal pressures on referrals ducts (37) and (39) when it is in the lower position (FIG. 3) in which case the device is turned off, without operating on the mill brake mechanism.

The aforementioned internal communications (24) that appears in the bottom of the hydraulic cylinder wall (16) allows the return of oil from the annular chamber (18) to the lower chamber of said cylinder normally occurs when the piston moves in the movement up.

The same internal communication (24) allows fluid to stay in the lower internal chamber is ejected into the annular chamber (18) when the same piston (12) makes its downward stroke.

Observing now FIG. 4, it can understand that when water containing the storage tank reaches its maximum, the excess fluid entering by said duct (11) the float moving in upstroke, (41), so that the valve (38) closes the communication passage to the return line (39) in a manner that disrupts the flow of fluid.

In the case above, the oil is confined in the upper chamber of the hydraulic cylinder causing the downward movement of said piston (12) which carries its stem (4) to actuate the brake mechanism of the mill.

When it gets to consume water stored in the tank of the mill, the aforementioned cylindrical (10) immediately, discharging the water is flushed through the same pipe contained (11) since, as shown in FIG. 1, is at a higher level that that water storage tank. In this case, the float falls (41) dragging the directional valve (38) to be located in the position to free communication with the return line (39), consequently stops hydraulic downward pressure on the piston (12), balancing them, in which case the force of return spring mill moves up the stem (4) releasing the brake to re-pump.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

1- HYDRAULIC DEVICE THAT COMMANDS AND ACTIONS, SO AUTOMATICS THE BRAKE OF A PUMPING WINDMILL of the type comprising vertical hydraulic cylinder whose smaller stem diameter your piston it is projects up out of the device, to link with the brake mill mechanics, said hydraulic cylinder being enclosed within a coaxial cylindrical container larger diameter to define an annular chamber between them which acts as deposit of oil that drives the displacement piston, characterized because to boost oil stored in the annular chamber and transmit on the piston hydraulic pressure, be referred to the use of two suction pumps blower of simple effect, located at the top of the set, which are activated by a same rocker operated from the pump rod of the mill; While a valvular means inserted in the oil circuit driven by simple effect, causes to the hydraulic cylinder piston moves applying the brake when interrupted his return to the annular chamber

2- HYDRAULIC DEVICE THAT COMMANDS AND ACTIONS, SO AUTOMATICS THE BRAKE OF A PUMPING WINDMILL, as according to claimed 1, wherein the valvular medium inserted in the oil circuit driven pumps, it is a directional valve contributor hosted on a stretch of communication between the ducts recirculation and return to the inside of the annular chamber

3- HYDRAULIC DEVICE THAT COMMANDS AND ACTIONS, SO AUTOMATICS, THE BRAKE OF A PUMPING WINDMILL, as claimed in 2, wherein the directional valve contributor has a orifice through which stays matches internal pressures in the ducts recirculation and return of oil when it is in the down position.

4- HYDRAULIC DEVICE THAT COMMANDS AND ACTIONS, SO AUTOMATICS, THE BRAKE OF A PUMPING WINDMILL according to claim 1, wherein the valve directional contributor is associated with a float housed inside a cylindrical container provided on the water storage tank in communication with the interior.

5- HYDRAULIC DEVICE THAT COMMANDS AND ACTIONS, SO AUTOMATICS, THE BRAKE OF A PUMPING WINDMILL , according to claim 1, wherein the sucker rod, through pusher stops acts on the fork longiforme to transmit simultaneously on reciprocating suction pumps blowers.

6- HYDRAULIC DEVICE THAT COMMANDS AND ACTIONS, SO AUTOMATICS, THE BRAKE OF A PUMPING WINDMILL as claimed in 5, wherein the fork longiforme through joints for acts on the stems of the suction pumps and blowers, producing the reciprocating movement up and down their respective pistons through corresponding suction tubes housed inside the annular chamber, producing the opening of their dump valves sending oil to the upper chamber of the hydraulic cylinder.

7- HYDRAULIC DEVICE THAT COMMANDS AND ACTIONS, SO AUTOMATICS, THE BRAKE OF A PUMPING WINDMILL, as according to claimed 1, wherein when the piston rises and stays high, both pumping oil pumps alternately, it is moved recirculation through to the point where is located the directional valve contributor sandwiched in communication with the return line to the annular internal chamber

8- HYDRAULIC DEVICE THAT COMMANDS AND ACTIONS, SO AUTOMATICS, THE BRAKE OF A PUMPING WINDMILL, as according to claimed 1, wherein at a lower point of the hydraulic cylinder wall, establishing an internal communication with annular chamber, allowing the return of the oil from the annular chamber towards the lower chamber of the said cylinder when the piston moves upward movement.
